(19) United States
(12) Patent Application Publication
(10) Pub. No.: US 2004/0134882 A1
(43) Pub. Date: Jul. 15, 2004

(54) UV-curable polymerizable mixture

(76) Inventor: Ping Mei, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/342,795

(22) Filed: Jan. 15, 2003

(51) Int. Cl. B44C 1/22

(52) U.S. Cl. 216/40

(57) ABSTRACT

An improved UV-curable polymerizable mixture comprises a compensation agent, a photoinitiator, and optionally, a cross-linker. Upon curing, the polymerizable mixture becomes a polymer that is more readily removable (e.g., by solvent or ion etching) than conventional UV-cured polymers. The improved polymerizable mixtures may be used in soft lithography applications, for example, as a mask used to protect a portion of an underlying layer during an etching process. The polymerizable mixture may also be used in other applications including, without limitation, during micromachining, in MEMS, as an optical cladding, as a coating, as an adhesive, as a sealant, as a potting medium, as an encapsulant, or for waterproofing.

### BACKGROUND

Conventional (i.e., photo-) lithography is generally not suitable for use to manufacture chips having features that are smaller than approximately 0.1 μm. Chips having such features may be manufactured by other technologies, such as soft lithography (e.g., micro-imprinting).

Typically, in soft lithography, tiny patterns are created on the surface of a material using a “pattern-transfer element” or “stamp” that has a three-dimensional structure molded onto its surface. The stamps are typically made from an elastomer that deforms under the influence of a force and regains its shape when the force is removed. The elasticity of the stamps is generally why this technology is referred to as “soft” lithography.

An exemplary soft lithography process uses a stamp to emboss a substrate coated with a layer of polymerizable mixture or compound which is then cured to form a polymer. The polymer is typically used as a mask, in a manner comparable to photolithography. That is, the mask protects certain portions of the chip against subsequent processing (etching, deposition, etc.) performed on the unmasked portions of the chip. After such processing, the mask is removed, so that subsequent semiconductor manufacturing steps may be performed.

Various types of polymers can be used for masking in soft lithography processes, including UV-curable and thermoplastic polymers. For example, a polymerizable mixture is applied on a substrate (either per se, or possibly on top of one or more layers of materials), a stamp is applied to the mixture, and the mixture is cured, thereby transferring fine features on the stamp to the substrate after the imprinted polymer is released from the stamp. A polymerizable mixture is said to be cured when the mixture is polymerized and transformed into a solid state. Generally, the curing process involves cross-linking and polymerization of monomers in the mixture.

One disadvantage of many commonly available UV-curable polymerizable mixtures is that they tend to be difficult to remove. More specifically, they become resistant to commonly used removal (e.g., wet or dry chemical etching) processes after the polymers have been cross-linked (i.e., cured). This is because such polymerizable mixtures were originally developed primarily for adhesive applications (e.g., Norland optical adhesive, 83H) , and thus are generally epoxy or polyurethane based. Epoxy or polyurethane based polymers have high overall crosslink density and, thus, tend to be solvent resistant. As a result, epoxy- or polyurethane-based UV-cured polymers typically have to be removed by more expensive and/or elaborate processes, such as an extended oxygen plasma process. Even after using such a relatively elaborate process, unacceptable amounts of residual polymer may still remain. This is problematic when a subsequent process (e.g., formation of another layer of material/feature on top) requires a surface that is substantially free of residual polymer.

For example, FIG. 1 illustrates an exemplary SEM image of residual polymer on a chromium (Cr) pad. The conventional UV-curable polymerizable mixture, Norland optical adhesive 83H, was applied to the pad. The mixture was then cured to form a polymer, and the pad was treated with an extended oxygen plasma process to remove the polymer. However, as illustrated by the whitish-appearing specks at the edges and (to a lesser extent) in the middle of the pad, a significant amount of polymer residue remains on the pad. Thus, this surface is not perfectly usable for subsequent lithography steps that require a clean surface. Other popular formulations of epoxy- or polyurethane-based UV-curable polymerizable mixtures, including hexanediol diacrylate and Bayer's Roskydal with photoinitiator, lead to the same problem.

Conventional UV-cured polymers may be undesirable in certain processes (e.g., soft lithography) as a result of the composition of the polymerizable mixture, which typically includes a cross-linker and a photoinitiator.

First, the photoinitiator (upon exposure to UV) provides a source of highly reactive free radicals that cause the molecules in the cross-linker to become polymerized and cross-linked upon reaction with the free radicals, thereby forming a polymer. The presence of the photoinitiator in the mixture, which increases the overall volume of the polymerizable mixture for a given volume of cross-linker, makes it relatively more difficult to coat a thin layer onto a substrate. In addition, such coating may require a longer curing process. Generally, the smaller the cross-linker molecule, the more 3-dimensional volume of polymer mixture is needed.

Further, the cross-linker is a small molecule precursor (e.g., monomer, low molecular weight oligomer, etc.) that is capable of forming long, high crosslink density polymer chains when polymerized. Formation of long, high crosslink density polymer chains inhibits removal of the polymer by chemical etching processes (e.g., via a solvent).

In many applications, the fact that such polymers are difficult to remove makes them particularly suitable for applications requiring permanence, toughness, and strength. Examples of some such applications include epoxies and other adhesives, protective coatings, encapsulants and potting materials. However, in certain other applications, such a high degree of permanence is not desirable. Such applications include not only soft lithography (mentioned above), but also traditional applications (as anyone who has ever tried to remove excess epoxy from a work piece can readily attest).

Thus, a market exists for an improved UV-curable polymerizable mixture that is relatively easier to remove (e.g., by using wet or dry chemical etching or other solvent-based processes). Such a mixture would be especially useful in soft lithography as well as a host of other processes.

### SUMMARY

An exemplary improved UV-curable polymerizable mixture comprises a compensation agent, a photoinitiator, and an (optional) cross-linker.

An exemplary method for forming a polymer mask comprises forming a layer of a polymerizable mixture (including a compensation agent, a photoinitiator, and optionally, a cross linker) above a substrate, patterning the polymerizable mixture, curing the patterned polymerizable mixture to form a patterned polymer, and removing some of the patterned polymer to leave a polymer mask.

An exemplary method for using a polymerizable mixture in a lithography process comprises applying a polymerizable mixture (including a compensation agent, a photoinitiator, and optionally, a cross linker) above a substrate, creating a polymer by cross-linking molecular bonds in the mixture upon absorption of UV photons, and removing any undesired polymer by etching (e.g., wet or dry etching). Optionally, prior (or subsequent) feature layers may have been (or be) formed using similar or other lithographic processing steps.

An exemplary electronic device or other lithographic structure may be produced as a product of the above process.

Other exemplary alternative embodiments and aspects are also disclosed. For example and without limitation, the UV-curable polymerizable mixture (and the resulting UV-cured polymer) may also be used in other applications besides lithography.

### BRIEF DESCRIPTION OF THE FIGURES

FIG. 1 illustrates an exemplary SEM image of residual polymer in the case of application of a conventional UV-curable polymerizable mixture followed by polymer removal using an extended oxygen plasma process.

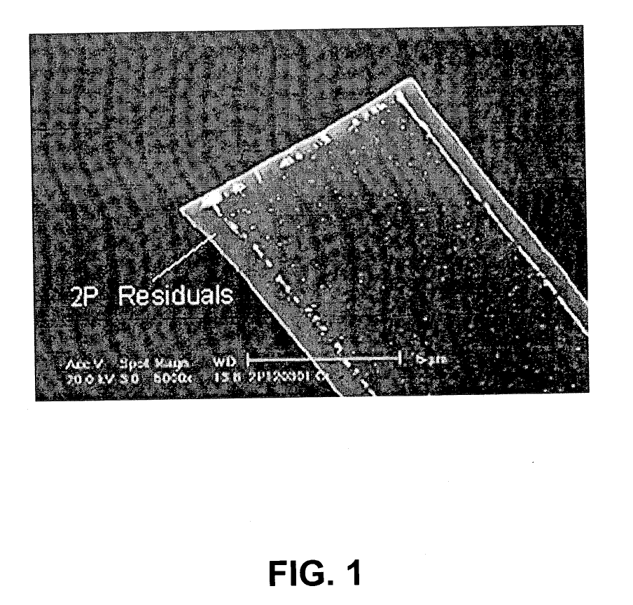

FIG. 2 illustrates an exemplary SEM image of residual polymer in the case of application of an improved UV-curable polymerizable mixture followed by polymer removal using a solvent etching process.

FIGS. 3A-3E illustrate an exemplary soft lithography application, in connection with which various embodiments of this patent may be implemented.

FIG. 4 illustrates an exemplary method for using an exemplary polymerizable mixture in a lithography process.

### DETAILED DESCRIPTION

I. Overview

Section II describes exemplary improved UV-curable polymerizable mixtures

Section III describes an exemplary implementation of an exemplary polymerizable mixture, and the result after removal of the cured polymer by solvent etching.

Section IV describes an exemplary soft lithography application, in connection with which the various exemplary embodiments to be described herein may be implemented.

Section V illustrates an exemplary method for using such a polymerizable mixture in a lithography process.

Section VI illustrates other exemplary applications.

II. Exemplary Improved UV-Curable Polymerizable Mixtures

A. Three Element Mixture

An exemplary improved UV-curable polymerizable mixture comprises a cross-linker, a photoinitiator, and a compensation agent. During manufacturing, the individual elements may be added together, then stirred using a magnetic stir mixer, turbulent agitation, blending, and/or other mixing methods known in the art.

A suitable cross-linker may include a small molecule precursor that is capable of forming long polymer chains when polymerized and cross-linked. In an exemplary implementation, the cross-linker includes a monomer or a low molecular weight oligomer that can be polymerized or cross-linked upon reaction with highly reactive free radicals (from the photoinitiator). For example, known compounds that may be used as exemplary cross-linkers include hexanediol diacrylate (HDDA), acrylate, methacrylate, vinyl-ester, vinyl-ethers, vinyl-alcohol, and styrene. These (and other) exemplary cross-linkers are well known and commercially available and need not be described in more detail herein.

A suitable photoinitiator absorbs UV photons and releases free radicals in response thereto. These free radicals, being extremely reactive, facilitate cross-linking among the molecules of the cross-linker. For example, an exemplary photoinitiator might includes, Irgacure 651 (2,2-dimethoxy-1, 2-diphenylethan-1-one) made by Ciba-Geigy.

As explained in the Background section, UV-curable polymerizable mixtures comprising only the cross-linker and photoinitiator are known in the art, and are generally characterized as being rather difficult to remove—a disadvantage in soft lithography and other applications requiring removability. One technique for creating a more readily removable polymer includes adding a third element, referred to herein as a compensation agent, to the conventional 2-element polymerizable mixture. The compensation agent compensates for the difficult-to-remove characteristic of the 2-element mixture in a manner that makes the cured polymer more readily removable.

The compensation agent can enhance removability of the cured polymer in various ways. For example, the compensation agent could enhance the cross-linking, thereby indirectly facilitating removal of the cured polymer by reducing the required mixture (and hence polymer) volume. Or, the compensation agent could directly facilitate removal of the cured polymer by making the polymer more readily dissolvable (and/or dispersable) under the application of solvent (or dispersant).

For example, certain agents heretofore used in optical (as opposed to soft) lithography, such as negative photoresists, can be applied as a liquid, dry and solidify, and yet thereafter (at least in the absence of photons and/or developer) remain readily removable by a solvent or oxygen plasma. These characteristics make negative photoresists suitable candidates for use as compensation agents.

Negative photoresists have long been used in conventional photolithography processes, particularly in multi-step masking and etching processes that involve thermal processing. However, thermal processing is generally undesirable for high throughput manufacture pattern transfer processes (e.g., micro-imprinting). This is one reason that negative photoresists may not have been used in soft lithography processes. Another reason is that negative photoresist by itself is viscous, making it very difficult to apply a thin coating of the photoresist on a surface (as is often required in soft lithography) and/or to be embossed. For these reasons, conventional wisdom has held that negative photoresists are not appropriate for use in soft lithography—at least not prior to the present discovery of their usability for improved polymerizable mixtures.

Generally, combining a cross-linker together with a compensation agent such as a negative photoresist provides one or more advantages especially applicable in soft lithography processes: (1) many commonly available negative photoresists have relatively larger molecules than the cross-linker, and a mixture of large and small molecules typically bonds more quickly during a curing process compared to a mixture with just small molecules; (2) the inherently UV-reactive nature of photoresists may further enhance cross-linking among the molecules, thereby reducing the amount of photoinitiator required; and/or (3) many photoresists are readily dissolvable during a subsequent etching process (e.g., via a solvent at room temperature).

Some well-known negative photoresists usable as compensation agents include Futurrex NR8 or NR9, as well as other solvent removable negative photoresists.

In an exemplary implementation using the exemplary photoresist compounds mentioned above, the ratio of cross-linker to compensation agent is in the range of approximately 1:1 to 4:1 by volume (approximately 1.2:1 to 5:1 by weight), and the ratio of compensation agent to photoinitiator is in the range of 2:1 to 15:1 by weight. Similarly, in an exemplary implementation, the cross linker makes up about 50%-80% of the total weight of the polymerizable mixture, the compensation agent makes up about 16%-45% of the total weight of the polymerizable mixture, and the photoinitiator makes up about 3%-7% of the total weight of the polymerizable mixture.

In another exemplary embodiment, a solvent may optionally be added to the polymerizable mixture. In this embodiment, suitable amounts of the solvent may be added to provide a desired viscosity and surface properties for soft lithography processes. For example, a solvent may be used to dilute the polymerizable mixture such that a thin layer of the polymerizable mixture may be more easily formed during a soft lithography process. Most solvents evaporate very quickly after coating (or formation) on a substrate, thus, adding a solvent typically has minimal effect on the properties of the polymerizable mixture other than improving the ease of coating that polymerizable mixture.

Exemplary solvents include, without limitation, surfactant, acetone, methyl ethyl ketone (MEK), and/or N-methylpyrrolidone (NMP). Solvents are well known and commercially available and need not be described in more detail herein.

B. Two Element Mixture

In yet another exemplary embodiment, the polymerizable mixture may omit the cross-linker entirely. In this embodiment, the polymerizable mixture may simply include the photoinitiator and the compensation agent. This is particularly the case when using compensation agents that are inherently polymerizable.

Such mixtures of compensation agent and photoinitiator will typically bond well when exposed to UV-light. However, such mixtures are generally more viscous than mixtures including a dedicated cross-linker, which generally has smaller molecules and is, therefore, less viscous. The more viscous the mixture, the more difficult it may be to coat a thin layer (e.g., when spin-coating a layer during lithography). For better results in such cases, a solvent may also be added to the exemplary two-element polymerizable mixture. The amount of solvent to be added will depend on the viscosity desired. In general, the considerations for selecting such a solvent are similar to those stated above with respect to the three-element polymerizable mixture, and need not be restated here.

In an exemplary implementation using negative photoresist as the compensation agent, the ratio of the compensation agent to photoinitiator is in the range of approximately 13:1 to 32:1 by weight. Similarly, in an exemplary implementation, the compensation agent makes up about 95%-97% of the total weight of the polymerizable mixture and the photoinitiator makes up about 3%-5% of the total weight of the polymerizable mixture.

C. Tabular Summary

Table 1 as shown below summarizes some exemplary UV-curable polymerizable mixtures and their respective components.

TABLE 1

| | | Exemplary | |
|---|---|---|---|
| Exemplary | | Make Up | |
| UV-curable | | (by weight) | |
| Polymerizable | Exemplary | of Each | Solvent - |
| Mixtures | Components | Components | Optional |
| 1 | Cross-linker | 50%-80% | As needed to achieve |
| | (e.g., | | a desired viscosity |
| | HDDA); | | and/or surface prop- |
| | | | erties. |
| | Compensation | 16%-45% | |
| | Agent (e.g., | | |
| | negative photo | | |
| | resist) | | |
| | Photoinitiator | 3%-7% | |
| | (e.g., Irgacure | | |
| | 651) | | |
| 2 | Compensation | 95%-97% | As needed to achieve |
| | Agent (e.g., | | a desired viscosity |
| | negative photo | | and/or surface prop- |
| | resist) | | erties. |
| | Photoinitiator | 3%-5% | |
| | (e.g., Irgacure | | |
| | 651) | | |

III. An Exemplary Implementation and Results

In an exemplary implementation, an exemplary UV-curable polymerizable mixture comprises HDDA (cross-linker), Futurrex NR8 (compensation agent), and Irgacure 651 (photoinitiator). The volume ratio between HDDA and the Futurrex NR8 is 2:1. The percentage of Irgacure 651 by weight is about 5% of the total polymerizable mixture. The UV-curable polymerizable mixture is mixed by a magnetic stir mixer.

The polymerizable mixture is then spin coated on a silicon wafer having a thin Cr coating. The coating of polymerizable mixture is then imprinted with a stamp UV-cured to form a patterned polymer. UV curing processes are well known in the art and need not be described in more detail herein. The intrusion features of the stamp may not completely clear some of the polymerizable mixture under these features. Thus, some remaining portions of the patterned polymer are removed by oxygen plasma process to form a polymer mask. Portions of the Cr film that are unprotected by the polymer mask is etched to form Cr pads (or structures), which are protected by the polymer mask. The polymer mask is then removed by acetone (i.e., a wet chemical removing process).

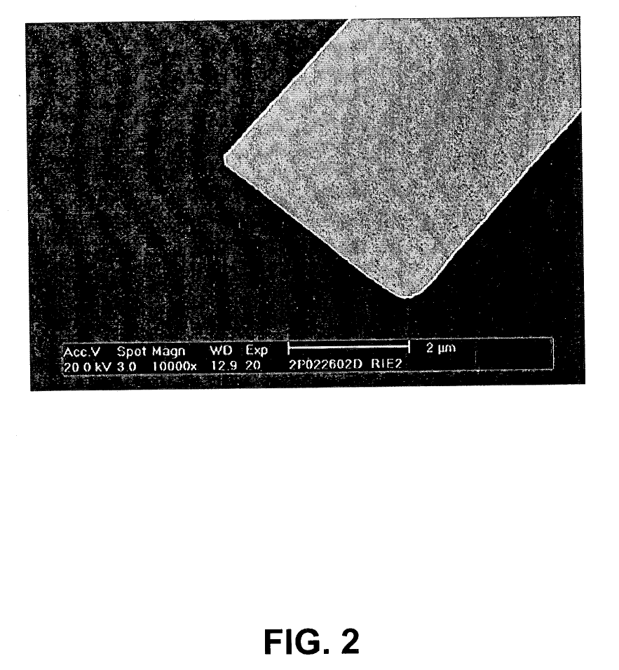

FIG. 2 illustrates a SEM image of a Cr pad after removal of the polymer mask as described above. As can be seen in FIG. 2, the Cr pad is substantially cleaner compared to using conventional UV-curable mixtures, and is thus more readily usable for subsequent processing.

IV. An Exemplary Soft Lithography Application

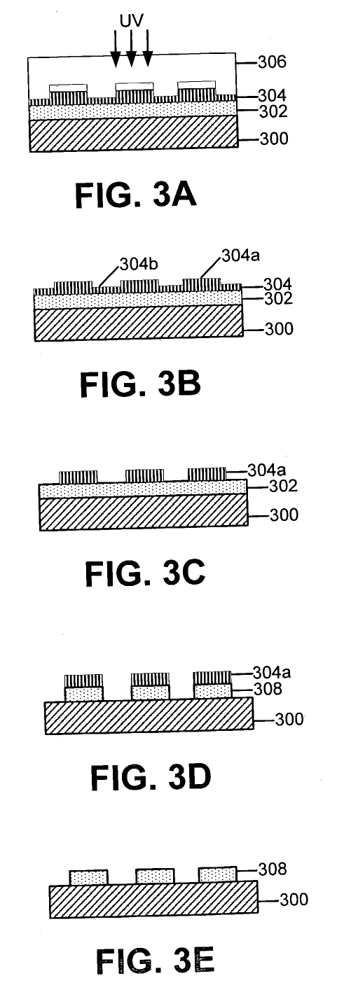

FIGS. 3A-3E illustrate an exemplary soft lithography application for making an electronic device (e.g., a semiconductor chip, etc.) in connection with which the various embodiments described herein may be implemented.

In FIG. 3A, a metal layer 302 is formed on a substrate 300, and a layer of polymerizable mixture 304 is formed on top of the metal layer 302. A UV-transparent stamp 306 is used to stamp the layer of polymerizable mixture 304. (The white spaces between the polymer 304 and stamp 306 represent gaps that are often formed in processing, either deliberately or inadvertently, but whose presence or function is not critical to this patent). The layer of polymerizable mixture 304 is cured through the application of UV (in this figure, from the top) to become a polymer layer.

In FIG. 3B, the stamp 306 is removed, leaving the polymer layer 304, including ridges 304a and valleys 304b, on top of the metal layer 302. Then, an etching process is performed to remove the residual polymer (in the valleys 304b) between the ridges 304a, resulting in polymer mask 304a as shown in FIG. 3C. In an exemplary implementation, any directional etching process known in the art, such as reactive ionic etching (RIE), may be used.

In FIG. 3D, the metal layer 302 is etched by any known dry or wet etching process, thereby removing those portions of the metal layer 302 that are not protected by the remaining polymer (or polymer mask), resulting in metal structures 308 beneath polymer mask 304a.

In FIG. 3E, the polymer mask 304a is removed by any known dry or wet etching process (e.g., via a solvent at room temperature).

In accordance with various exemplary embodiments described herein, the substrate and any structures on top of the substrate (e.g., metal structures 308) are now substantially free of residual polymer and ready for subsequent lithographic processing steps.

The application illustrated above is merely illustrative. One skilled in the art will recognize that the various exemplary UV-curable polymerizable mixtures (and resulting UV-cured polymers) described herein may be used with other soft lithography application (or other lithographic application in general) in accordance with the requirements of a particular implementation.

V. An Exemplary Soft Lithography Process

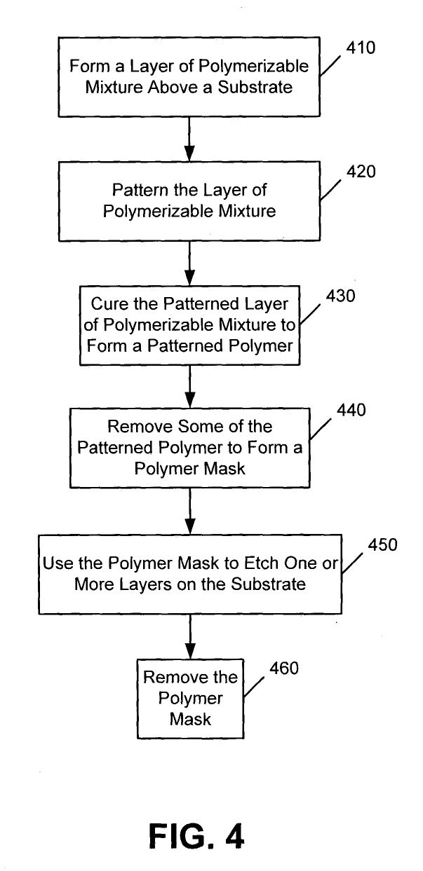

FIG. 4 illustrates, in flow chart format, an exemplary method for using an exemplary improved polymerizable mixture to create a polymer mask usable in a lithography process (to, for example, during manufacture an electronic device).

At step 410, a layer of a polymerizable mixture is formed. In one exemplary implementation, the polymerizable mixture includes a cross linker, a compensation agent, and a photoinitiator. In another exemplary implementation, the polymerizable mixture includes a compensation agent, a photoinitiator, and optionally a solvent.

At step 420, the layer of polymerizable mixture is patterned. In an exemplary implementation, the layer of polymerizable mixture is patterned by a pattern-transfer stamp.

At step 430, the layer of patterned polymerizable mixture is cured to form a patterned polymer. In an exemplary implementation, the patterned polymerizable mixture is cured by reaction to UV photons to form a patterned polymer.

At step 440, some of the patterned polymer is removed to form a polymer mask. In an exemplary implementation, a directional etching process is performed to remove some of the patterned polymer.

At step 450, the polymer mask is used during etching of one or more layers on the substrate. For example, the polymer mask may be used to etch an unmasked portion of the metal layer which is not protected by the polymer mask.

At step 460, the polymer mask is removed, for example, by etching using a solvent at room temperature or by any other desired process.

The foregoing illustrates one cycle of polymer mask creation (steps 410-440), etching (450), and removal (460) usable in soft lithography. This entire cycle may be performed either before or after, other layering operations, which layering operations may include similar and/or entirely conventional processing operations. The result of such lithographic processing may include an electronic device.

Furthermore, portions of cycle 410-460 can be used in other applications besides just soft lithography. For example, the subsequence of steps 410-440 can be used by itself to create a polymer mask without the associated etching (450) and removal (460) steps.

VI. Other Exemplary Applications

In the foregoing examples, the improved UV-curable polymerizable mixtures (and resulting UV-curable polymers) were used in electronics applications, such as integrated circuits manufacturing. However, the improved UV-curable polymerizable mixtures (and resulting UV-curable polymers) are certainly not limited so such applications. For example, they can also be used in micromechanical components (e.g., sensors, actuators, fluidic devices, etc.) created by lithographic processes, as well as so-called microelectromechanical (MEMS) systems integrating mechanical elements and electronics on a common substrate. More generally, the improved UV-curable polymerizable mixtures (and resulting UV-curable polymers) are usable in any application that selectively etches away portions of a layer and/or adds new layers using lithographic (or corresponding microfabrication) technologies. Even more generally, the improved UV-curable polymerizable mixtures (and resulting UV-curable polymers) may also be used in applications such as epoxies, adhesives, coatings, sealants, potting media, encapsulation media and/or waterproofing compounds. Such applications may support a variety of products, from optical cladding, to flooring coatings, to paint clear coating . . . any area where it is desired to have a strong, yet non-permanent, removable, etchable or otherwise workable polymer.

VII. Conclusion

The various exemplary embodiments described herein include exemplary improved UV-curable polymerizable mixtures for use with soft lithography processes. Those skilled in the art will appreciate that the improved UV-curable polymerizable mixtures may also be used with other types of lithographic and non-lithographic processes known in the art in accordance with the requirements of a particular implementation.

The foregoing examples illustrate certain exemplary embodiments from which other embodiments, variations, and modifications will be apparent to those skilled in the art. The inventions should therefore not be limited to the particular embodiments discussed above, but rather are defined by the claims.

What is claimed is:

1. A method for using a polymerizable mixture in a lithography process, comprising:
forming a layer of a polymerizable mixture above a substrate, said polymerization mixture including: a cross linker, a compensation agent, and a photoinitiator;
patterning said polymerizable mixture;
curing said patterned polymerizable mixture to form a patterned polymer; and
removing some of said patterned polymer to form a polymer structure.

2. The method of claim 1 further comprising:
using said polymer structure as a mask to facilitate etching of one or more layers on said substrate; and
removing said polymer mask using solvent etching.

3. The method of claim 1 further comprising:
using said polymer structure as a mask to facilitate etching of one or more layers on said substrate; and
removing said polymer mask using ion etching.

4. The method of claim 1, where a ratio of said cross linker to compensation agent is in the range of approximately 1:1 to 4:1.

5. The method of claim 1, where a ratio of said compensation agent to photoinitiator is in the range of approximately 2:1 to 15:1.

6. The method of claim 1, where said polymerizable mixture further includes a solvent.

7. The method of claim 4, where said solvent is used to achieve a desired viscosity.

8. The method of claim 4, where said solvent is used to achieve desired surface properties.

9. An improved UV-curable polymerizable mixture, comprising:
a cross-linker;
a photoinitiator; and
a compensation agent.

10. The polymerizable mixture of claim 9, where a ratio of said cross linker to compensation agent is in the range of approximately 1:1 to 4:1.

11. The polymerizable mixture of claim 9, where said cross linker includes a low molecular weight oligomer that can be polymerized.

12. The polymerizable mixture of claim 9, where said compensation agent includes a negative photoresist.

13. The polymerizable mixture of claim 9, where said photoinitiator includes a material that absorbs UV photons.

14. The polymerizable mixture of claim 9, where said photoinitiator includes a material that releases free radicals upon exposure to UV photons.

15. The polymerizable mixture of claim 9, where said polymerizable mixture further comprises a solvent.

16. The polymerizable mixture of claim 15, where said solvent includes a surfactant.

17. A method of creating a UV-cured polymer, comprising:
mixing a cross-linker, a compensation agent, and a photoinitiator to form a polymerizable mixture; and
curing said polymerizable mixture.

18. A UV-curable polymerizable mixture, comprising:
a compensation agent; and
a photoinitiator.

19. The polymerizable mixture of claim 18, where a ratio of said compensation agent to photoinitiator is in the range of approximately 13:1 to 32:1.

20. The polymerizable mixture of claim 18, where said photoinitiator includes a material that absorbs UV photons.

21. The polymerizable mixture of claim 18, where said photoinitiator includes a material that releases free radicals upon exposure to UV photons.

22. The polymerizable mixture of claim 18, further including a solvent.

23. The polymerizable mixture of claim 22, where said solvent is used to achieve a desired viscosity.

24. The polymerizable mixture of claim 22, where said solvent is used to achieve desired surface properties.

25. A method of creating a UV-cured polymer, comprising:
mixing a compensation agent and a photoinitiator to form a polymerizable mixture; and
curing said polymerizable mixture.

26. A system for using a polymerizable mixture in a lithography process, comprising:
means for forming a layer of a polymerizable mixture above a substrate, said polymerization mixture including: a cross linker, a compensation agent, and a photoinitiator;
means for patterning said polymerizable mixture;
means for curing said patterned polymerizable mixture to form a patterned polymer;
means for removing some of said patterned polymer to form a polymer mask; and
means for using said polymer mask to facilitate etching of one or more layers on said substrate.

27. A lithographic structure made by a process comprising a plurality of layering operations, at least one of said layering operations including:
forming a layer of a polymerizable mixture above a substrate, said polymerization mixture including: a cross linker, a compensation agent, and a photoinitiator;
patterning said polymerizable mixture;
curing said patterned polymerizable mixture to form a patterned polymer;
removing some of said patterned polymer to form a polymer mask;
using said polymer mask to facilitate etching one or more layers on said substrate; and
removing said polymer mask.

28. The lithographic structure of claim 27 configured as an electronic device.

29. The lithographic structure of claim 27, configured as a micromechanical device.

30. The lithographic structure of claim 29, configured as a MEMS device.

31. A system for creating a UV-cured polymer, comprising:
means for applying a polymerizable mixture above a substrate, said polymerizable mixture including a compensation agent and a photoinitiator; and
means for creating a polymer by cross-linking molecular bonds in said mixture upon absorption of UV photons.

32. A method for using a UV-curable polymerizable mixture in a lithographic process, comprising:
applying a polymerizable mixture above a substrate, said polymerizable mixture including a compensation agent and a photoinitiator;
creating a polymer by cross-linking molecular bonds in said mixture upon absorption of UV photons; and
removing any undesired polymer.

33. The method of claim 32, where said polymerizable mixture further includes a cross-linker.

34. A structure made by a lithographic process comprising a plurality of layering operations, at least one of said layering operations including::
applying a polymerizable mixture above a substrate, said polymerizable mixture including a compensation agent and a photoinitiator;
creating a polymer by cross-linking molecular bonds in said mixture upon absorption of UV photons; and
removing any undesired polymer.
